(19) United States
(12) Patent Application Publication
(10) Pub. No.: US 2017/0045925 A1
(43) Pub. Date: Feb. 16, 2017

(54) SYSTEMS AND METHODS OF CONTROLLING A POWER SUPPLY SIGNAL DELIVERED TO AN ELECTRONIC DEVICE

(71) Applicant: Power IT Perfect, Inc., Charlotte, NC (US)

(72) Inventor: Travis Ray Neely, Murphy, TX (US)

(21) Appl. No.: 15/217,317

(22) Filed: Jul. 22, 2016

Related U.S. Application Data
(60) Provisional application No. 62/349,563, filed on Jun. 13, 2016.
(60) Provisional application No. 62/196,705, filed on Jul. 24, 2015.

(51) Int. Cl. G06F 1/32; G05F 1/66; H02J 13/00

(52) U.S. Cl. CPC G06F 1/324; H02J 13/0096; G05F 1/66

(57) ABSTRACT

Systems and methods of controlling a power supply signal delivered to an electronic device are provided. In one exemplary embodiment, a method performed by a controller for controlling a power supply signal delivered to an electronic device may include obtaining one or more power control signals based on a portion of a power delivery profile of the electronic device that corresponds to a certain position in an operation phase of the electronic device. The power delivery profile may represent predetermined power to be delivered to the electronic device in the operation phase of the electronic device. Each power control signal may be related to the predetermined power to be delivered to the electronic device proximate a corresponding position in the operation phase of the electronic device. Further, the method may include outputting the one or more power control signals proximate the certain position to control the power supply signal delivered to the electronic device so that a power consumed by the electronic device corresponds to the predetermined power delivered to the electronic device proximate the certain position.

### CROSS-REFERENCE TO RELATED APPLICATIONS

This application claims benefit under 35 U.S.C. §119(e) to U.S. Prov. App. No. 62/349,563, filed Jun. 13, 2016, and U.S. Prov. App. No. 62/196,705, filed Jul. 24, 2015, which are hereby incorporated by reference as if fully set forth herein.

### FIELD OF DISCLOSURE

The present disclosure relates generally to the field of electronics, and in particular to controlling a power supply signal delivered to an electronic device.

### BACKGROUND

Traditional power supply applications provide continuous linear power delivery as needed by an electronic device leaving the electronic device to determine when and how to consume the power. Extra circuits are typically added to limit undesired effects on the electronic device such as from over or under-consumption of power. In one example, filters may be added to the power supply circuit to maintain a certain voltage level when the electronic device initially draws more current than the power supply is capable of providing or to reduce current spikes by the electronic device. However, even with the use of filters, these power supplies result in higher power consumption by the electronic device.

In some power supply applications, to reduce power consumption, pulse width modulation (PWM) is used to control how often the power supply provides power to an electrical device (e.g., motor, battery charger, digital logic or the like). In PWM, the average value of voltage and/or current provided to an electronic device is controlled by a switch device rapidly switching on or off a power supply signal to deliver discontinuous, non-linear power to the electronic device. The longer the duty cycle of each PWM pulse, the higher the average power provided to the electronic device. Further, the PWM switching frequency is typically much greater than a frequency that would affect the electronic device. The main advantage of PWM is that the power consumed by the switch device is very low compared to the aggregate power saved by the electronic device when the switch device is switched off. However, traditional PWM-based power supplies are designed to conform to broad design requirements such as providing a constant voltage or current or a certain pattern of PWM pulse signals to an electronic device.

Accordingly, there is a need for improved techniques for controlling a power supply signal delivered to an electronic device. In addition, other desirable features and characteristics of the present disclosure will become apparent from the subsequent detailed description and embodiments, taken in conjunction with the accompanying figures and the foregoing technical field and background.

The Background section of this document is provided to place embodiments of the present disclosure in technological and operational context, to assist those of skill in the art in understanding their scope and utility. Unless explicitly identified as such, no statement herein is admitted to be prior art merely by its inclusion in the Background section.

### SUMMARY

The following presents a simplified summary of this disclosure in order to provide a basic understanding to those of skill in the art. This summary is not an extensive overview of the disclosure and is not intended to identify key/critical elements of embodiments of this disclosure or to delineate the scope of this disclosure. The sole purpose of this summary is to present some concepts disclosed herein in a simplified form as a prelude to the more detailed description that is presented later.

Briefly described, embodiments of the present disclosure relate to systems and methods for controlling a power supply signal delivered to an electronic device. According to one aspect, a method performed by a controller for controlling a power supply signal delivered to an electronic device may include obtaining one or more power control signals based on a portion of a power delivery profile of the electronic device that corresponds to a certain position in an operation phase of the electronic device. The power delivery profile may represent predetermined power to be delivered to the electronic device in the operation phase of the electronic device. Each power control signal may be related to the predetermined power to be delivered to the electronic device proximate a corresponding position in the operation phase of the electronic device. Further, the method may include outputting the one or more power control signals proximate the certain position to control the power supply signal delivered to the electronic device so that a power consumed by the electronic device corresponds to the predetermined power delivered to the electronic device proximate the certain position.

According to another aspect, a controller for controlling a power supply signal delivered to an electronic device may be configured to include an obtainer circuit and an output circuit. The obtainer circuit may be configured to obtain one or more power control signals based on a portion of a power delivery profile of the electronic device that corresponds to a certain position in a power phase of the electronic device. The power delivery profile may represent predetermined power to be delivered to the electronic device in the operation phase of the electronic device. Further, each power control signal may be related to the predetermined power to be delivered to the electronic device proximate a corresponding position in the operation phase of the electronic device. The output circuit may be configured to output the one or more power control signals proximate the certain position to control the power supply signal delivered to the electronic device so that a power consumed by the electronic device corresponds to the predetermined power delivered to the electronic device proximate the certain position.

According to another aspect, a system for controlling a power supply signal delivered to an electronic device may include a power supply, a switch device and a controller. The power supply may provide a power supply signal. The switch device may be operationally coupled between the electrical device and the power supply. The controller may be operationally coupled to the switch device. Further, the controller may be configured to obtain one or more power control signals based on a portion of a power delivery profile of the electronic device that corresponds to a certain position in an operation phase of the electronic device. The power delivery profile may represent predetermined power to be delivered to the electronic device in the operation phase of the electronic device. Each power control signal may be related to the predetermined power to be delivered to the electronic device proximate a corresponding position in the operation phase of the electronic device. In addition, the controller may output, to the switch device, the one or more power control signals proximate the certain position to control the power supply signal delivered to the electronic device so that a power consumed by the electronic device corresponds to the predetermined power delivered to the electronic device proximate the certain position.

According to another aspect, a method performed by a controller for controlling a power supply signal delivered to a stator of an electric motor may include obtaining one or more power control signals based on a portion of a power delivery profile of the stator that corresponds to a certain position in an operation phase of the stator. The power delivery profile may represent predetermined power to be delivered to the stator in the operation phase of the electronic device. Each power control signal may be related to the predetermined power to be delivered to the stator proximate a corresponding position in the operation phase of the stator. Further, the certain position may be determined based on an axial position of a rotor of the electric motor. The method may include outputting the one or more power control signals proximate the certain position to control the power supply signal delivered to the stator so that a power consumed by the stator corresponds to the predetermined power to be delivered to the stator proximate the certain position.

According to another aspect, a controller for controlling a power supply signal delivered to a stator of an electric motor may be configured to include an obtainer circuit and an output circuit. The obtainer circuit may be configured to obtain one or more power control signals based on a portion of a power delivery profile of the stator that corresponds to a certain position in a power phase of the stator. The power delivery profile may represent predetermined power delivered to the stator based on the operation phase of the electric motor. Each power control signal may be related to the predetermined power to be delivered to the stator proximate a corresponding position in the operation phase of the stator. The output circuit may be configured to output the one or more power control signals proximate the certain position to control the power supply signal delivered to the stator so that a power consumed by the stator corresponds to the predetermined power to be delivered to the stator proximate the certain position.

According to another aspect, a system for controlling a power supply signal delivered to a stator of an electric motor may include a power supply, a switch device and a controller. The power supply may provide a power supply signal. The switch device may be operationally coupled between the stator of the electric motor and the power supply. The controller may be operationally coupled to the switch device and may be configured to obtain one or more power control signals based on a portion of a power delivery profile of the stator that corresponds to a certain position in an operation phase of the stator. The power delivery profile may represent predetermined power to be delivered to the stator in the operation phase of the electronic device. Each power control signal may be related to the predetermined power to be delivered to the stator proximate a corresponding position in the operation phase of the stator. The certain position determined based on an axial position of a rotor of the electric motor. The controller may be further configured to output, to the switch device, the one or more power control signals proximate the certain axial position of the rotor to control the power supply signal delivered to the stator so that a power consumed by the stator corresponds to the power delivery profile of the stator proximate the certain position of the rotor.

According to another aspect, a method performed by a controller for controlling a power supply signal delivered to a light source device may include obtaining one or more power control signals based on a portion of a power delivery profile of the light source device that corresponds to a certain position in an operation phase of the light source device. The power delivery profile may represent predetermined power delivered to the light source device in the operation phase of the light source device. Each power control signal may be related to the predetermined power to be delivered to the light source device proximate a corresponding position in the operation phase of the light source device. Further, the certain position may be determined based on a certain time in the operation phase of the light source device. The method may include outputting the one or more power control signals proximate the certain position to control the power supply signal delivered to the light source device so that a power consumed by the light source device corresponds to the predetermined power delivered to the light source device proximate the certain position.

According to another aspect, a controller for controlling a power supply signal delivered to light source device may include an obtainer circuit and an output circuit. The obtainer circuit may be configured to obtain one or more power control signals based on a portion of a power delivery profile of the light source device that corresponds to a certain position in an operation phase of the light source device. The power delivery profile may represent predetermined power to be delivered to the light source device in the operation phase of the light source device. Each power control signal may be related to the predetermined power to be delivered to the light source device proximate a corresponding position in the operation phase of the light source device. Further, the certain position may be determined based on a certain time in the operation phase of the light source device. The output circuit may be configured to output the one or more power control signals proximate the certain position to control the power supply signal delivered to the light source device so that a power consumed by the light source device corresponds to the predetermined power to be delivered to the light source device proximate the certain position.

According to another aspect, a system for controlling a power supply signal delivered to light source device may be configured to include a power supply, a switch device and a controller. The power supply may provide a power supply signal. The switch device may be operationally coupled between the light source device and the power supply. The controller may be operationally coupled to the switch device and may be configured to obtain one or more power control signals based on a portion of a power delivery profile of the light source device that corresponds to a power phase of the light source device. The power delivery profile may represent predetermined power delivered to the light source device in an operation phase of the light source device. Each power control signal may be related to the predetermined power to be delivered to the light source device proximate a corresponding position in the operation phase of the light source device. Further, the certain position may be determined based on a certain time in the operation phase of the light source device. The controller may be configured to output the one or more power control signals proximate the certain position to control the power supply signal delivered to the light source device so that a power consumed by the light source device corresponds to the predetermined power to be delivered to the light source device proximate the certain position.

### BRIEF DESCRIPTION OF THE DRAWINGS

The present disclosure will now be described more fully hereinafter with reference to the accompanying drawings, in which embodiments of this disclosure are shown. However, this disclosure should not be construed as limited to the embodiments set forth herein. Rather, these embodiments are provided so that this disclosure will be thorough and complete, and will fully convey the scope of this disclosure to those skilled in the art. Like numbers refer to like elements throughout.

FIG. 1 illustrates one embodiment of a system for controlling a supply signal delivered to an electronic device in accordance with various aspects described herein.

FIG. 2 illustrates one embodiment of a controller for controlling a supply signal delivered to an electronic device in accordance with various aspects described herein.

FIG. 3 illustrates another embodiment of a controller for controlling a supply signal delivered to an electronic device in accordance with various aspects described herein.

FIG. 4 illustrates another embodiment of a controller for controlling a supply signal delivered to an electronic device in accordance with various aspects described herein.

FIG. 5 illustrates one embodiment of a method of controlling a supply signal delivered to an electronic device in accordance with various aspects described herein.

FIGS. 6A-C illustrate one embodiment of a system for controlling a supply signal delivered to an electric motor in accordance with various aspects described herein.

FIGS. 7A-B illustrate embodiments of a method of controlling a supply signal delivered to one or more stators of an electric motor in accordance with various aspects described herein.

FIGS. 8A-B illustrate additional embodiments of a method of controlling a supply signal delivered to one or more stators of an electric motor in accordance with various aspects described herein.

FIGS. 9A-B provide examples of determining duty cycles of power control signals based on a portion of a power delivery profile that corresponds to a certain position in an operation phase of an electronic device in accordance with various aspects described herein.

FIGS. 10A-C provide examples of power control signals applied to stators of an electric motor.

FIGS. 11A-C provide examples of power delivery profiles of electrical devices in accordance with various aspects described herein.

FIGS. 12A-D provide an example of determining a power delivery profile of the electrical device in accordance with various aspects described herein.

FIG. 13 illustrates one embodiment of a method of controlling a supply signal delivered to a stator of an electric motor in accordance with various aspects described herein.

### DETAILED DESCRIPTION

For simplicity and illustrative purposes, the present disclosure is described by referring mainly to exemplary embodiments thereof. In the following description, numerous specific details are set forth in order to provide a thorough understanding of the present disclosure. However, it will be readily apparent to one of ordinary skill in the art that the present disclosure may be practiced without limitation to these specific details.

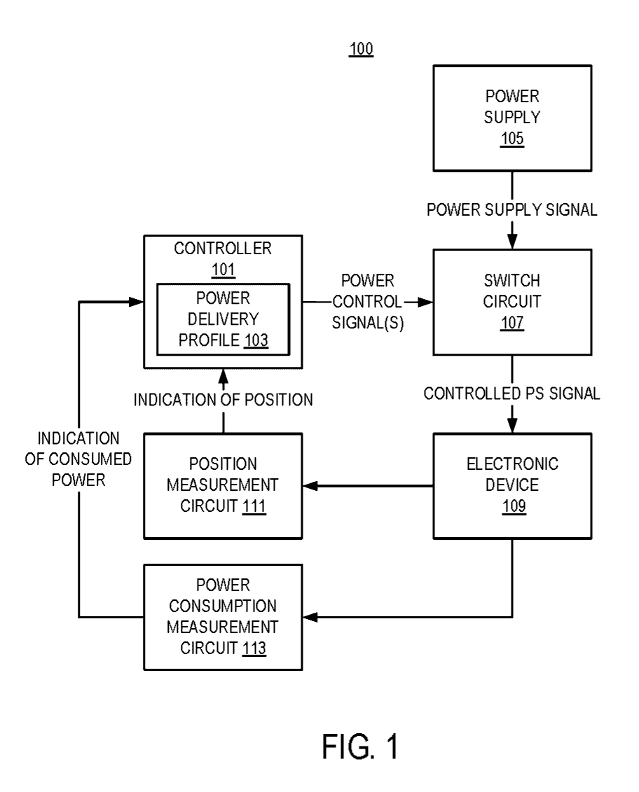

In this disclosure, systems and methods of controlling a supply signal delivered to an electronic device are provided. For example, FIG. 1 illustrates one embodiment of a system 100 for controlling a supply signal delivered to an electronic device 109 in accordance with various aspects described herein. In FIG. 1, the system 100 may include a controller 101, a power supply 105, a switch device 107, the electronic device 109, a position measurement circuit 111, a power consumption measurement circuit 113, or any combination thereof. The controller 101 may include a power delivery profile 103 that represents predetermined power to be delivered to the electronic device 113 in an operation phase of the electronic device 113. In one example, the power delivery profile 103 may be based on the performance, power consumption or both of the electronic device 113. The term power as used herein may also indicate a voltage, a current, or the like where appropriate. The power delivery profile 103 may be represented as predetermined power 219a-n of the electronic device as a function of position 217a-n in the operation phase of the electronic device. In one example, the power delivery profile 103 may represent predetermined current to be delivered to the electronic device 113 in an operation phase of the electronic device 113 such as to reduce the power consumption of the electronic device 113. In another example, the power delivery profile 103 may represent the predetermined voltage to be delivered to the electronic device 113 in an operation phase of the electronic device 113 such as to increase the performance of the electronic device 113. In another example, the power delivery profile 103 may represent the desired power to be delivered to the electronic device 113 in an operation phase of the electronic device 113 such as to achieve a balance of the power consumption and the performance of the electronic device 113. The power delivery profile 103 may be predetermined by the controller 101, determined independent of the controller 101 such as by a processor operationally coupled to the controller, dynamically determined by the controller 101, or adaptively determined by the controller 101. In one example, the power delivery profile 103 may be stored in the memory of the controller 101. In another example, the power delivery profile 103 may be dynamically determined by the controller based on measuring the power consumed by the electronic device 113 at various times or positions during the operation phase of the electronic device 113. In another example, the power delivery profile 103 may be adaptively determined by modifying the power delivery profile 103.

In FIG. 1, the power supply 105 may provide a power supply signal such as a direct current (DC), an alternating current (AC) signal, or both. The switch device 107 may be controlled by the controller 101 to deliver the power supply signal to the electronic device 113. The switch device 107 may also be referred to as a driver circuit where appropriate. The switch device 107 may be any electronic device capable of interrupting the power supply signal delivered to the electronic device 113. In one example, the switch device 107 may be a field effect transistor (FET) such as a metal oxide semiconductor FET (MOSFET). In another example, the switch device 107 may be a bipolar transistor such as an insulated-gate bipolar transistor. The electronic device 113 may be any device capable of being powered by a discontinuous, non-linear power supply signal. For instance, the electronic device 113 may be an electrical machine such as an electric motor, a battery charger, a light source device such as a light emitting diode (LED), a servomechanism such as a servomotor, a heating element such as used in consumer appliances, a digital logic circuit, the like, or any combination thereof.

In the current embodiment, the position sensor circuit 111 may be configured to sense a position in an operation phase of the electronic device 109. The term operation phase may also be referred to as a power phase where appropriate. The term position may correspond to a mechanical position, a time, a temperature, a displacement, a brightness, a luminance, a chrominance, a radiant energy, an event, or any other condition that indicates a point or range in an operation phase of the electronic device 109. In one example, the position may be a mechanical position of a rotor of an electric motor used to indicate a point or range in an operation phase of a stator of the electric motor. In another example, the position may be a time interval or a relative or absolute time in the “on” cycle of a digital logic circuit that is used to indicate a point or range in an operation phase of an electronic device. The position measurement circuit 111 may include a position sensor, a timer, a device for measuring a position, the like, or any combination thereof. For example, the position sensor may be a Hall effect sensor, a rotary encoder sensor or any sensor capable of measuring a position of a mechanical device. In another example, the timer may be a mechanical timer, an electromechanical timer, an electronic timer such as a hardware or software timer, or any device capable of measuring a time or a time interval. The power consumption measurement circuit 113 may be configured to measure a power, a current, a voltage, a mechanical power such as torque, or the like consumed by the electronic device 109 at an instant in time or over a time interval. The power consumption measurement circuit 113 may include a power sensor, a current sensor, a voltage sensor, a mechanical power sensor such as a torque sensor, a sensor associated with measuring power consumed by an electrical device, the like, or any combination thereof.

In FIG. 1, the controller 101 may obtain one or more power control signals based on a portion of the power delivery profile 103 of the electronic device 109 that corresponds to a certain position in the operation phase of the electronic device 109. Each power control signal may be related to the predetermined power to be delivered to the electronic device 109 proximate a corresponding position in the operation phase of the electronic device 109. Further, the one or more power control signals may be used by the controller 101 to control the power supply signal delivered to the electronic device so that a power consumed by the electronic device 109 corresponds to the predetermined power to be delivered to the electronic device 109 proximate the certain position in the operation phase of the electronic device 109. In one example, each power control signal may be one or more pulse signals having a certain duty cycle or frequency. In another example, each power control signal may be one or more pulse-width modulated signals. In another example, each power control signal may be a pseudo-random binary sequence having a certain duty cycle or frequency. In another example, each power control signal may be a pseudo noise code (PN code) having a certain duty cycle or frequency. In another example, a duty cycle and a frequency of at least two power control signals may be different. The controller 101 may then output the one or more power control signals to the switch circuit 107 proximate the certain position in the operation phase of the electronic device 109 to control the power supply signal output by the power supply 105. The controlled power supply signal may then be delivered to the electronic device 109 so that a power consumed by the electronic device 109 corresponds to the predetermined power to be delivered to the electronic device 109 proximate the certain position.

In another embodiment, the controller 101 may determine a position in the operation phase of the electronic device 109. Further, the controller 101 may determine a duty cycle or frequency of the one or more power control signals based on a portion of the power delivery profile 103 that corresponds to the certain position. The duty cycle or frequency of each power control signal may be related to the predetermined power to be delivered to the electronic device 109 proximate a corresponding position in the operation phase of the electronic device 109. For instance, a lower duty cycle of the one or more power control signals corresponds to a lower power and a higher duty cycle of the one or more power control signals corresponds to a higher power. A duty cycle is typically expressed as a percentage with 0% duty cycle corresponding to no power and 100% duty cycle corresponding to full power. The controller 101 may determine the duty cycle or frequency of the one or more power control signals based on the power consumed by the electronic device 109 and a predetermined power to be delivered to the electronic device 109 proximate the certain position. As previously mentioned, this predetermined power is derived from the power delivery profile 103 of the electronic device 109. In one example, the power delivery profile 103 may include duty cycle or frequency 218a-n as a function of position 217a-n in the operation phase of the electronic device.

In another embodiment, the controller 101 may determine the duty cycle or frequency of the one or more power control signals by adapting the duty cycle or frequency of the one or more power control signals based on the power consumed by the electronic device 109 and a predetermined power to be delivered to the electronic device 109 proximate the certain position. In one example, the controller 101 may adapt the duty cycle or frequency of the one or more power control signals by changing the duty cycle or frequency of the one or more power control signals when the power consumed by the electronic device 109 is different from the predetermined power to be delivered to the electronic device 109 proximate the certain position.

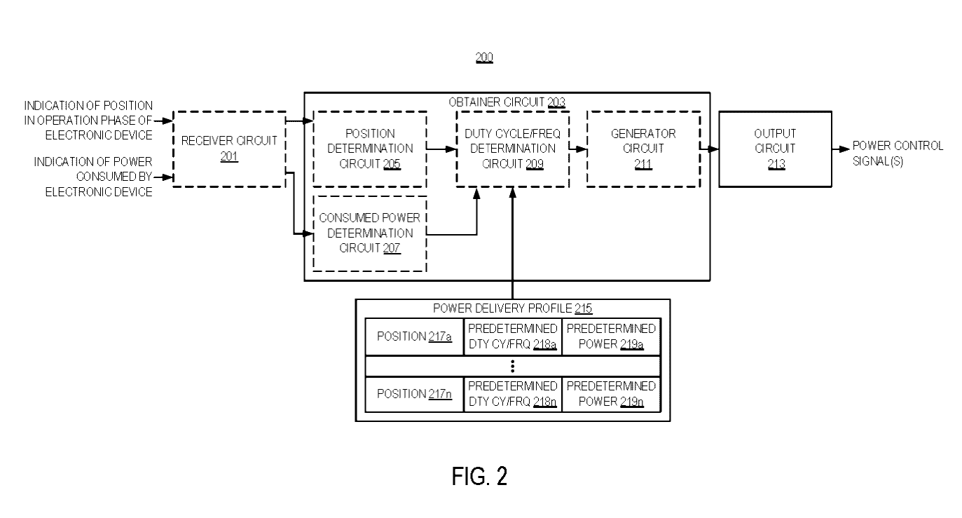

FIG. 2 illustrates one embodiment of a controller 200 for controlling a supply signal delivered to an electronic device in accordance with various aspects described herein. In FIG. 2, the controller 200 may include a receiver circuit 201, an obtainer circuit 203, an output circuit 213, and a power delivery profile 215. The receiver circuit 201 may be configured to receive an indication of a certain position in an operation phase of the electronic device. Further, the receiver circuit 201 may be configured to receive an indication of a power consumed by the electronic device proximate the certain position. In response to receiving the indication of the certain position, the obtainer circuit 203 may be configured to obtain one or more power control signals based on a portion of the power delivery profile 211 of the electronic device that corresponds to the certain position in the operation phase of the electronic device. Further, each power control signal may be output proximate to receiving the indication of the certain position in the operation phase of the electronic device. The obtainer circuit 203 may include a position determination circuit 205, a consumed power determination circuit 207, a duty cycle or frequency determination circuit 209, a generator circuit 207, the like, or any combination thereof. The position determination circuit 205 may be configured to determine a position in the operation phase of the electronic device. In one instance, the position determination circuit 205 may determine a position in the operation phase of the electronic circuit responsive to receiving an indication of the position such as from a sensor or a timer. The consumed power determination circuit 207 may be configured to determine a power consumed by the electronic device proximate a certain position in the operation phase of the electronic device. In one example, the consumed power determination circuit 207 may determine a power consumed by the electronic device responsive to receiving an indication of the consumed power such as from a power sensor or a circuit used to measure the power consumed by the electronic device. The duty cycle or frequency determination circuit 205 may be configured to determine a duty cycle or frequency of the one or more power control signals based on a portion of the power delivery profile that corresponds to the certain position in the operation phase of the electronic device. Further, the determination circuit 205 may be configured to adapt the duty cycle or frequency of the one or more power control signals based on the consumed power and the predetermined power to be delivered to the electronic device proximate the certain position. For instance, the determination circuit 205 may increase the duty cycle or frequency of the one or more power control signals when the consumed power is less than the predetermined power to be delivered to the electronic device proximate the certain position. Similarly, the determination circuit 205 may decrease the duty cycle or frequency when the consumed power is greater than the predetermined power proximate the certain position. In addition, the generator circuit 207 may be configured to generate the one or more power control signals based on the determined duty cycle or frequency.

In FIG. 2, the output circuit 209 may be configured to output the one or more power control signals proximate the certain position to control the power supply signal delivered to the electronic device so that a power consumed by the electronic device corresponds to the predetermined power to be delivered to the electronic device (as represented by the power delivery profile 215) proximate the certain position in the operation phase of the electronic device. As previously described, the power delivery profile 103 may be represented as predetermined power 219a-n of the electronic device as a function of position 217a-n in the operation phase of the electronic device. In operation, the controller 200 may receive a certain position in the operation phase of the electronic device and may then determine whether the certain position corresponds to one of the positions 217a-n in the power delivery profile 103. If so, then the controller 200 may obtain one or more power control signals based on the corresponding predetermined power 219a-n to be delivered to the electronic device proximate the certain position. In one instance, the controller 200 may determine a duty cycle or a frequency of the one or more power control signals to control a power supply signal delivered to the electronic device so that the power consumed by the electronic device corresponds to the predetermined power 219a-n proximate the certain position. In another instance, the power delivery profile 211 may include a predetermined duty cycle or frequency 214a-n as a function of the position 217a-n to allow the controller 200 to generate one or more power control signals that correspond to a certain position 213a-n. In yet another instance, the controller 200 may adapt one or more of the predetermined duty cycle or frequency 214a-n of the one or more of the power control signals based on a different between the consumed power and the predetermined power 219a-n proximate the certain position.

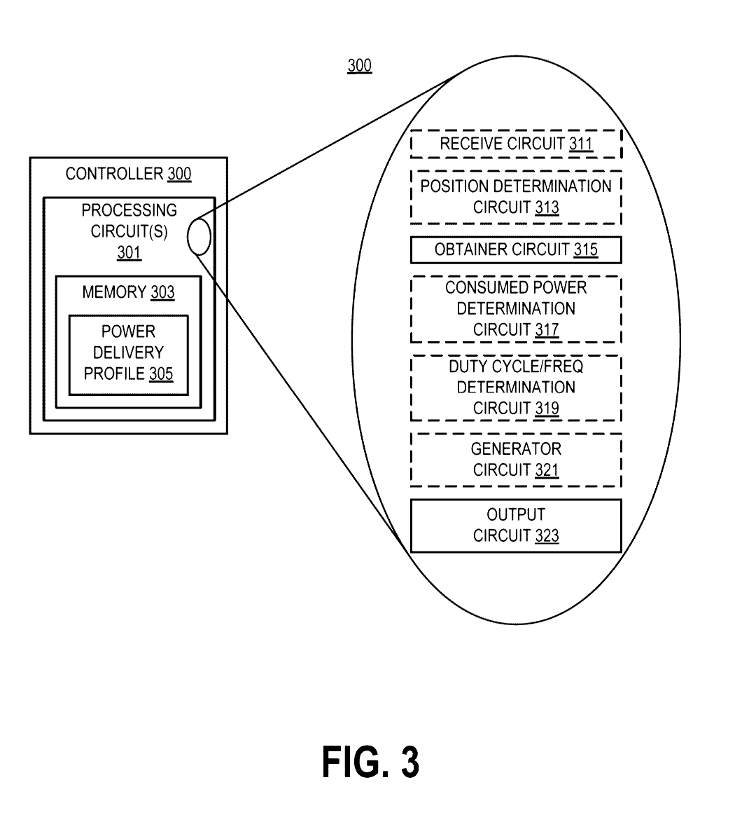

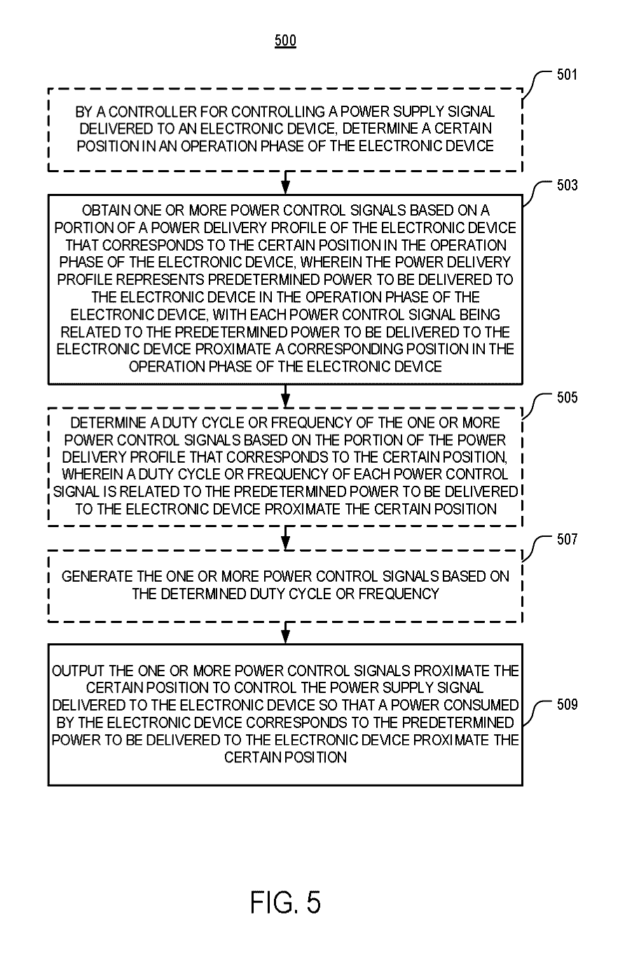

FIG. 3 illustrates another embodiment of a controller 300 for controlling a supply signal delivered to an electronic device in accordance with various aspects described herein. In FIG. 3, the controller 300 may include one or more processing circuits 301 and memory 303. The processing circuits 301 may be configured to perform any of the processing described herein (e.g., the method of FIG. 5) such as by executing instructions stored in the memory 303. The processing circuits 301 may implement certain functional means, units or modules. These functional means, units, or modules (e.g., for implementing the method of FIG. 5), may include a receive circuit 311 for receiving an indication of a certain position in an operation phase of an electronic device. Further, these functional means, units, or modules may include a position determination circuit 313 for determining the certain position based on the indication of the certain position. Also, these functional means, units, or modules may include an obtainer circuit 315 for obtaining one or more power control signals based on a portion of a power delivery profile of the electronic device that corresponds to the certain position in the operation phase of the electronic device. These functional means, units, or modules may include a consumed power determination circuit 317 for determining a power consumed by the electronic device proximate the certain position. In addition, these functional means, units, or modules may include a duty cycle or frequency determination circuit 319 for determining a duty cycle or frequency of the one or more power control signals based on the portion of the power delivery profile that corresponds to the certain position and a generator circuit 321 for generating the one or more power control signals based on the determined duty. Finally, these functional means, units, or modules may include an output circuit 323 for outputting the one or more power control signals proximate the certain position to control the power supply signal delivered to the electronic device so that a power consumed by the electronic device corresponds to the predetermined power to be delivered to the electronic device proximate the certain position

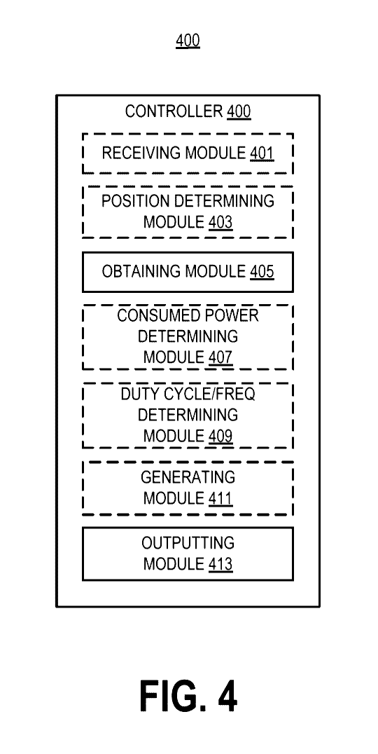

FIG. 4 illustrates another embodiment of a controller 400 for controlling a supply signal delivered to an electronic device in accordance with various aspects described herein. In FIG. 4, the controller 400 may implement various functional means, units or modules (e.g., via the processing circuits 301 in FIG. 3 and/or via software code. These functional means, units, or modules (e.g., for implementing the method of FIG. 5), may include a receiving module 401 for receiving an indication of a certain position in an operation phase of an electronic device. Further, these functional means, units, or modules may include a position determining module 403 for determining the certain position based on the indication of the certain position. Also, these functional means, units, or modules may include an obtaining module 405 for obtaining one or more power control signals based on a portion of a power delivery profile of the electronic device that corresponds to the certain position in the operation phase of the electronic device. These functional means, units, or modules may include a consumed power determining module 407 for determining a power consumed by the electronic device proximate the certain position. In addition, these functional means, units, or modules may include a duty cycle or frequency determining module 409 for determining a duty cycle or frequency of the one or more power control signals based on the portion of the power delivery profile that corresponds to the certain position and a generating module 411 for generating the one or more power control signals based on the determined duty. Finally, these functional means, units, or modules may include an outputting module 413 for outputting the one or more power control signals proximate the certain position to control the power supply signal delivered to the electronic device so that a power consumed by the electronic device corresponds to the predetermined power to be delivered to the electronic device proximate the certain position

FIG. 5 illustrates one embodiment of a method 500 of controlling a supply signal delivered to an electronic device in accordance with various aspects described herein. In FIG. 5, the method 500 may be performed by a controller for controlling the supply signal delivered to the electronic device. The method 500 may start, for instance, at block 501 where it may include determining a certain position in an operation phase of the electronic device. At block 503, the method 500 may include obtaining one or more power control signals based on a portion of a power delivery profile of the electronic device that corresponds to the certain position in the operation phase of the electronic device. The power delivery profile may represent predetermined power to be delivered to the electronic device in the operation phase of the electronic device. Further, each power control signal being related to the predetermined power to be delivered to the electronic device proximate a corresponding position in the operation phase of the electronic device. At block 505, the method 500 may include determining a duty cycle or frequency of the one or more power control signals based on the portion of the power delivery profile that corresponds to the certain position, wherein a duty cycle or frequency of each power control signal is related to the predetermined power to be delivered to the electronic device proximate the certain position. The duty cycle or frequency of each power control signal may be related to a power to be delivered to the electronic device proximate the certain position. At block 507, the method 500 may include generating the one or more power control signals based on the determined duty cycle or frequency. At block 509, the method 500 may include outputting the one or more power control signals proximate the certain position to control the power supply signal delivered to the electronic device so that a power consumed by the electronic device corresponds to the predetermined power TO BE delivered to the electronic device proximate the certain position.

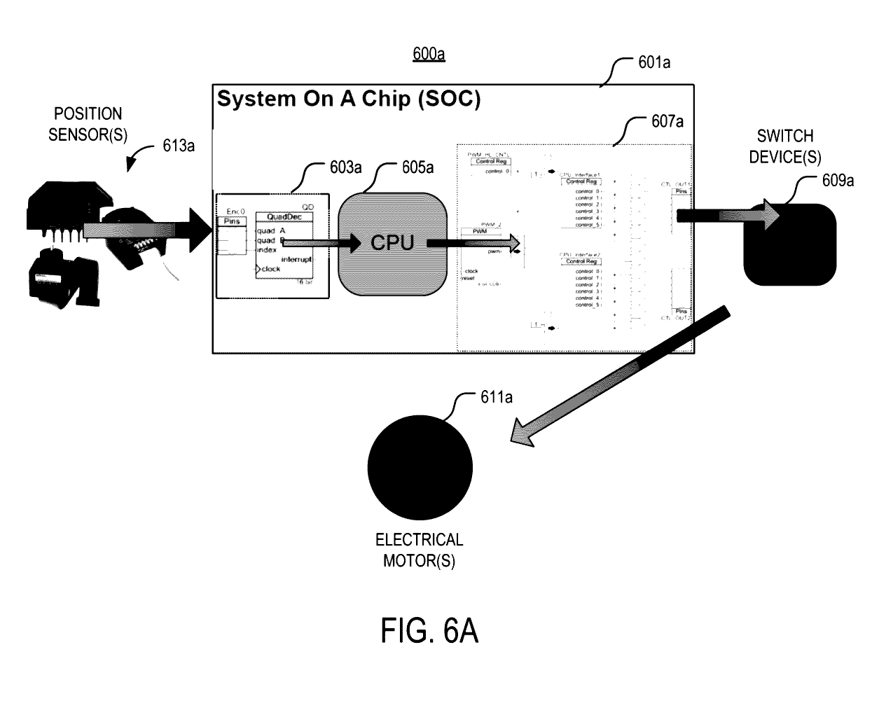

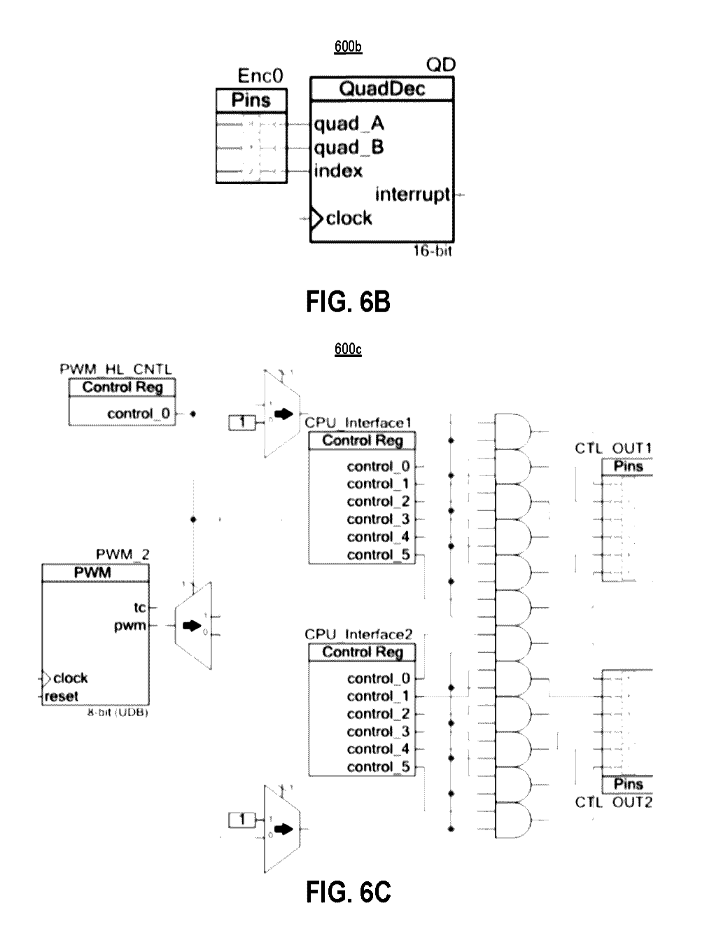

FIGS. 6A-C illustrate one embodiment of a system 600a-c for controlling a supply signal delivered to an electric motor in accordance with various aspects described herein. In FIG. 6A, the system 600a may include a controller 601a, a switch device 609a, an electrical motor 611a and a position sensor 613a. The controller 601a may be configured to include a receiver 603a, a processor 605a and a generator circuit 607a. The receiver 603a may be configured to receive an indication of a position of a rotor of the electrical motor 611a in the operation phase of a stator of the electrical motor 611a. Further, the receiver 603a may be configured to receive an indication of a power consumed by the stator. In one example, the receiver 603a may be configured to include an interrupt controller that is operationally coupled to the processor 605a, such as interrupt controller 600b as shown in FIG. 6B. The generator circuit 607a may be configured to generate the one or more power control signals based on a certain duty cycle or frequency. In one example, the generator circuit 607a may be configured to include a PWM generator such as PWM generator 600c as shown in FIG. 6C.

In FIG. 6A, the processor 605a may be configured to process computer instructions and data. The processor 605a may be configured as any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored-program, general-purpose processors, such as a microprocessor or Digital Signal Processor (DSP), together with appropriate software; or any combination of the above. In one definition, data is information in a form suitable for use by a computer. It is important to note that a person having ordinary skill in the art will recognize that the subject matter of this disclosure may be implemented using various operating systems or combinations of operating systems.

In this embodiment, the processor 605a may be configured to include memory. The memory may be configured to interface via a bus to the processor 605a to provide storage or caching of data or computer instructions during the execution of software programs such as the operating system, application programs, and device drivers. The memory may include read-only memory (ROM), random-access memory (RAM), or the like. The ROM may be configured to provide computer instructions or data to the processor 605a. The ROM may be configured to include memory such as programmable read-only memory (PROM), erasable programmable read-only memory (EPROM), electrically erasable programmable read-only memory (EEPROM), or the like.

The functionality of the methods described herein may be implemented in one of the components of the controller 601a or partitioned across multiple components of the controller 601a. Further, the functionality of the methods described herein may be implemented in any combination of hardware, software or firmware. Further, the processor 605a may be configured to communicate with any of such components over a bus. In another example, any of such components may be represented by program instructions stored in memory that when executed by the processor 605a performs the corresponding functions described herein. In another example, the functionality of any of such components may be partitioned between the processor 605a and the generator circuit 607a. In another example, the non-computative-intensive functions of any of such components may be implemented in software or firmware and the computative-intensive functions may be implemented in hardware.

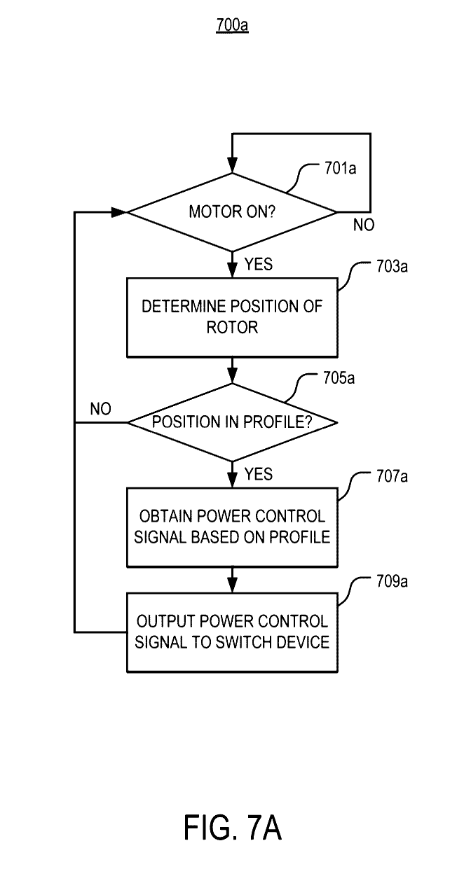

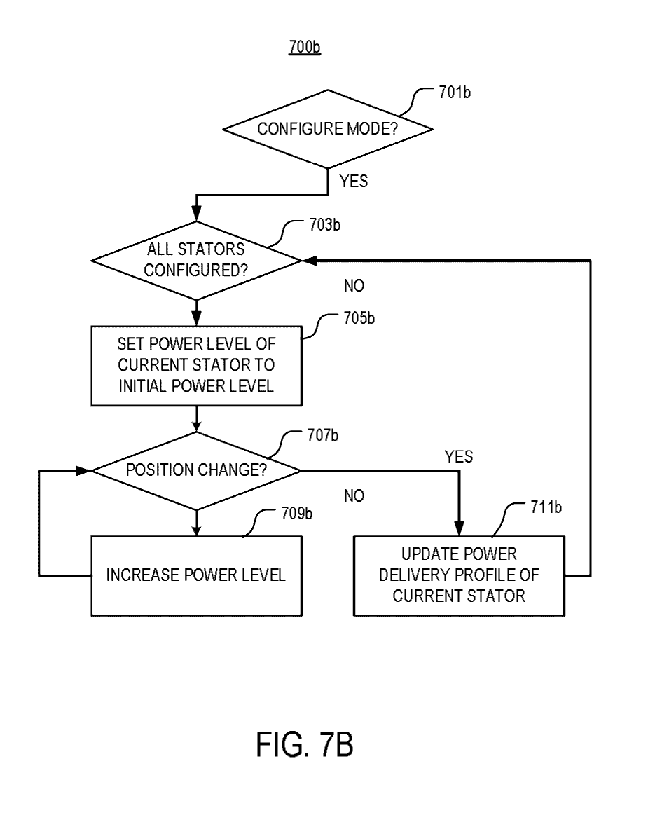

FIGS. 7A-B illustrate embodiments of a method 700a and 700b, respectively, of controlling a supply signal delivered to one or more stators of an electric motor in accordance with various aspects described herein. FIG. 7A illustrates one embodiment of the method 700a for controlling the supply signal delivered to the one or more stators of the electric motor. FIG. 7B illustrates one embodiment of the method 700b for determining a power delivery profile of each stator. In FIG. 7A, the method 700a may include controlling a supply signal delivered to the electric motor using a power delivery profile. The method 700a may start, for instance, at block 701a where it may include determining whether the electric motor is on. In one example, the electric motor is on when a rotor of the electric motor is moving relative to one or more stators of the electric motor. If the electric motor is on, at block 703a, the method 700a may include determining a position of a rotor of the electric motor. The position of the rotor may be an absolute position or a relative position. Further, the position of the rotor may be used to determine the position of one or more magnets on the rotor so that the electromagnets on the stator may be excited at the proper times. At block 705a, the method 700a may include determining whether the position of the rotor corresponds to a position in the power delivery profile. In response to determining that the position of the rotor corresponds to the position in the power delivery profile, the method 700a may obtain one or more power control signals based on the power delivery profile associated with such position of the rotor, as referenced at block 707a. The method 700a may include determining a duty cycle or frequency for the one or more power control signals based on the power delivery profile associated with the position of the rotor. The power delivery profile may include a duty cycle or frequency for one or more power control signals that correspond to a certain position of the rotor. At block 709a, the method 700a may include outputting to the switch device the one or more power control signals proximate the position of the rotor.

In FIG. 7B, the method 700b may start, for instance, at block 701b where it may include determining whether the electric motor is in a configuration mode. In response to determining that the electric motor is in the configuration mode, the method 700b may determine whether the power delivery profile for all stators of the electric motor are configured, as referenced at block 703b. In response to determining that the power delivery profiles for all stators are not configured, the method 700b may set a power level of the certain stator to an initial power level, as referenced at block 705b. The initial power level may be any power level between 0% and 100% of maximum power. In one example, the initial power level may represent a minimum power level at which the rotor may move. In another example, the initial power level may represent a power level that the rotor is expected to move. At block 707b, the method 700b may include determining whether a position of the rotor changed. In response to determining that the position of the rotor did not change, the method 700b may include increasing the power level. The power level may be non-linearly or linearly increased to a maximum power level. In one example, the power level may be increased in increments of 10% of the maximum power level. In response to determining that the position of the rotor changed, the method 700b may include updating the power delivery profile of the certain stator.

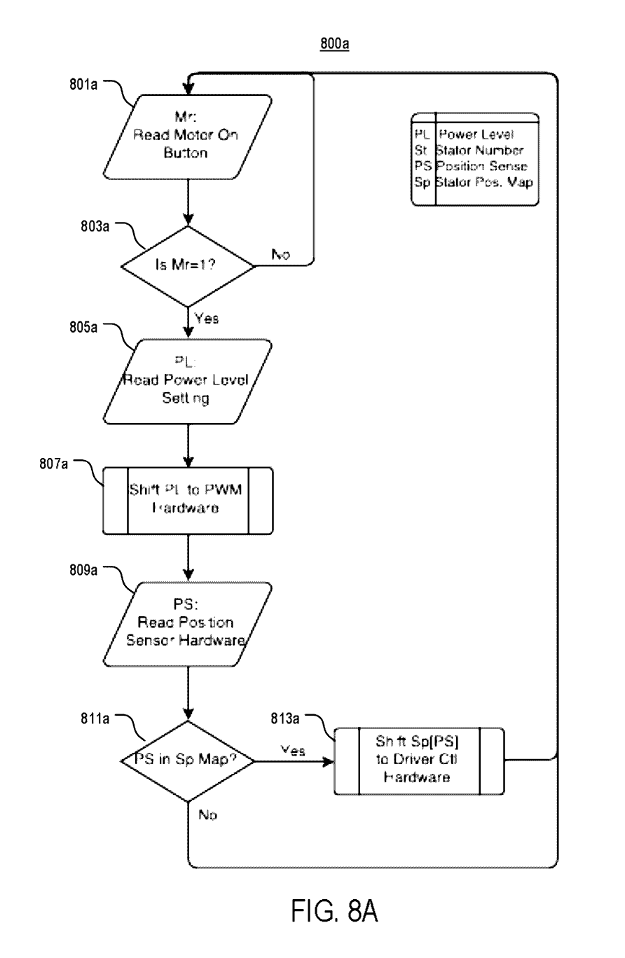

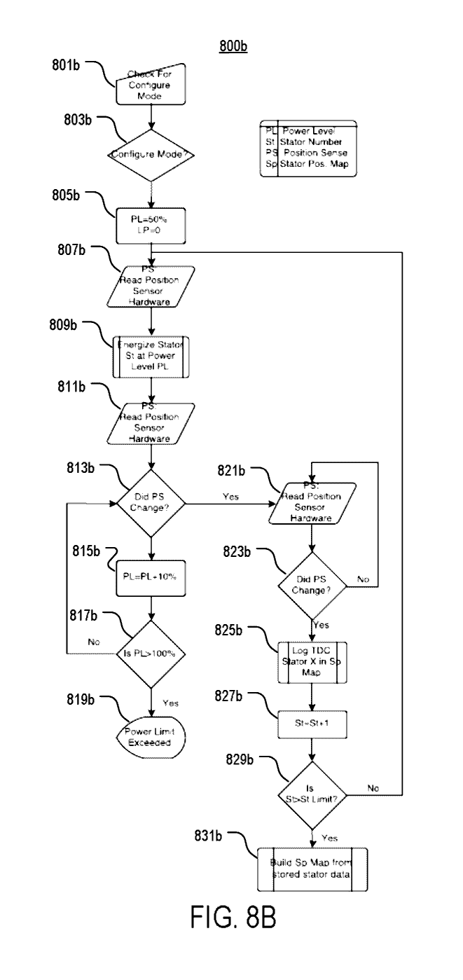

FIGS. 8A-B illustrate additional embodiments of a method 800a and 800b, respectively, of controlling a supply signal delivered to one or more stators of an electric motor in accordance with various aspects described herein. FIG. 8A illustrates one embodiment of the method 800a for controlling the supply signal delivered to each stator of the electric motor, which is associated with a stator number (St) in FIGS. 8A-B. FIG. 8B illustrates one embodiment of the method 800b for determining a power delivery profile of each stator, which is referred to as a stator position map (SP) in FIGS. 8A-B. In FIG. 8A, the method 800a may include controlling a supply signal delivered to the electric motor using a power delivery profile. The method 800a may start, for instance, at block 801a where it may include reading a motor enabled (e.g., “on”) button. At block 803a, the method 800a may include determining whether the motor is enabled. At block 805a, the method 800a may include reading a power level setting of the one or more stators, which is referred to a power level (PL) in FIGS. 8A-B. At block 807a, the method 800a may include shifting the power level control to the PWM hardware. After the PWM hardware is activated, the method 800a may include reading a position of the rotor from a position sensor, which is referred to a position sense (PS) in FIGS. 8A-B. At block 811a, the method 800a may include determining whether the position of the rotor is in the power delivery profile of the stator. In response to determining that the position of the rotor in in the power delivery profile of the stator, the method 800a may include determining one or more power control signals based on the power delivery profile proximate the corresponding position of the rotor, as referenced at block 813a. Otherwise, the method 800a may continue to block 801a.

In FIG. 8B, the method 800b may start at, for instance, block 801b or 803b where it may include checking for a configure mode for the electric motor. In response to determining that the configure mode is enabled, the method 800b may include setting a power level of a power to be delivered to the electric motor, as referenced at block 805b. The power level may be set to an initial power between 0% and 100% of the maximum power that may be delivered to the one or more stators of the electric motor. In one example, the initial power is set to 50% of the maximum power. At block 807b, the method 800b may include receiving an indication of a first position of a rotor of the electric motor from a position sensor that is operationally coupled to the electric motor. At block 809b, the method 800b may include providing the initial power to one or more of the stators. At block 811b, the method 800b may include receiving an indication of a second position of a rotor of the electric motor from a position sensor that is operationally coupled to the electric motor. At block 813b, the method 800b may include determining whether the position of the rotor changed based on the first and second positions of the rotor. In response to determining that the position of the rotor did not change, the method 800b may include increasing the power level of the stator, as referenced at block 815b. At block 817b, the method 800b may determine whether the power delivered to the stator is greater than the maximum power level. In response to determining that the power delivered to the stator is greater than the maximum power level, the method 800b may determine that the power limit of the stator is exceeded. The method 800b may indicate that the stator is defective and may continue to the next stator.

In FIG. 8B, in response to determining that the position of the rotor changed, the method 800b may include receiving an indication of a third position of the rotor from the position sensor. Again, at block 823b, the method 800b may include determining whether the position of the rotor changed based on the second and third positions. For instance, if the second and third positions are different, then the rotor changed positions. However, if the second and third positions are the same, then the rotor has not changed positions. In response to determining that the position of the rotor changed, the method 800b may including logging this position in the power delivery profile of the current stator, as referenced at block 825b. At block 827b, the method 800b may include incrementing the stator number to indicate that the configuration associated with the next stator will be performed. At block 829b, the method 800b may include determining whether there are any more stators to be configured. If there is a stator to be configured, then the method 800b may proceed to block 807b where it may include configuring the next stator. Otherwise, the method 800b may include building the power delivery profile for the stators.

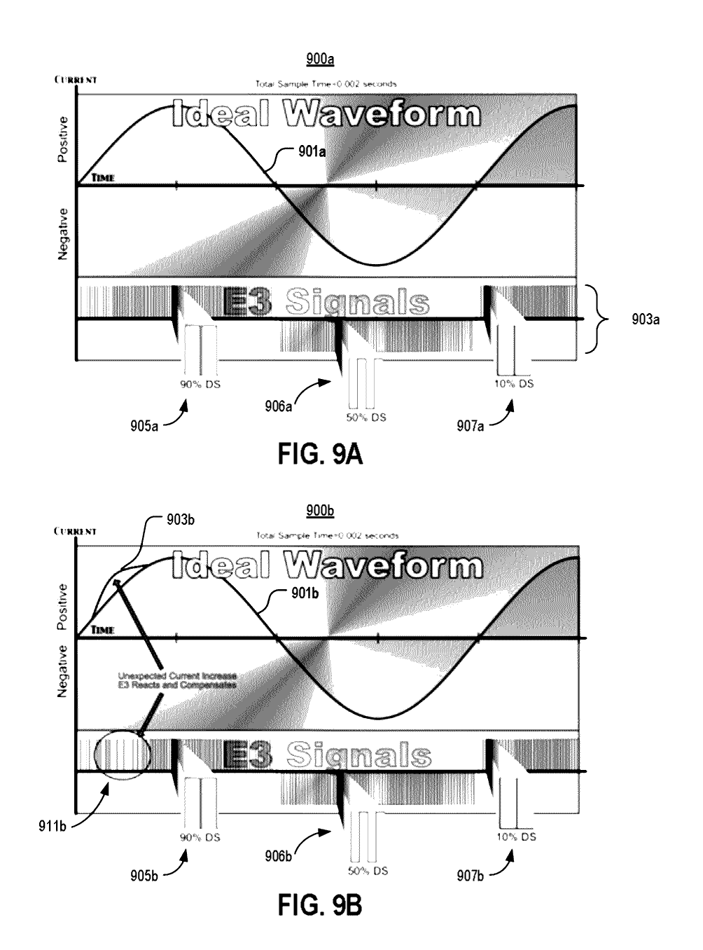

FIGS. 9A-B provide examples 900a-b of determining duty cycles of power control signals based on a portion of a power delivery profile 901a-b that corresponds to a certain position in an operation phase of an electronic device in accordance with various aspects described herein. FIG. 9A shows the power delivery profile 901a representing predetermined power (e.g., current) to be delivered to an electronic device in the operation phase of the electronic device. It is important to recognize that the power delivery profile 901a does not represent providing a constant current to the electronic device. Instead, the power delivery profile 901a represents the current required to allow the electronic device to operate with improved power efficiency. In FIG. 9A, a duty cycle is determined for each power control signal 905a-907a based on a portion of the power delivery profile 901a that corresponds to a certain position (e.g., time) in the operation phase of the electronic device. A higher duty cycle may be determined for one or more power control signals 905a that are near peak power of the power delivery profile 901a. Also, a lower duty cycle may be determined for one or more power control signals 907a and 909a that are below the peak power of the power delivery profile 901a.

FIG. 9B shows the power delivery profile 901b representing predetermined power (e.g., current) to be delivered to an electronic device in the operation phase of the electronic device. A duty cycle is determined for each power control signal 905b-907b based on a portion of the power delivery profile 901b that corresponds to a certain position (e.g., time) in the operation phase of the electronic device. As shown in FIG. 9B, a duty cycle of each of one or more power control signals, as represented by the highlighted region 911b, may be adapted based on a change to the power consumed by the electronic device, as represented by line 911b. This change in the power consumed by the electronic device may be associated with many factors such as a change in the environmental conditions of the electronic device such as temperature, humidity or ageing, a change in the operation of the electronic device, a change in the power supply that provides the power supply signal, a change in the input load of the electronic device, the like, or any combination thereof.

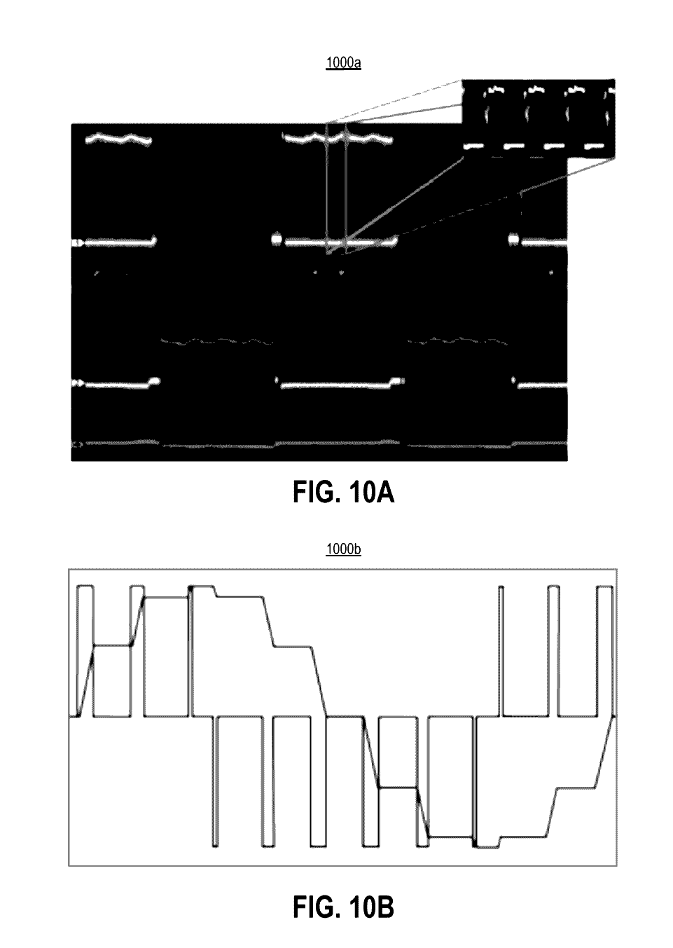

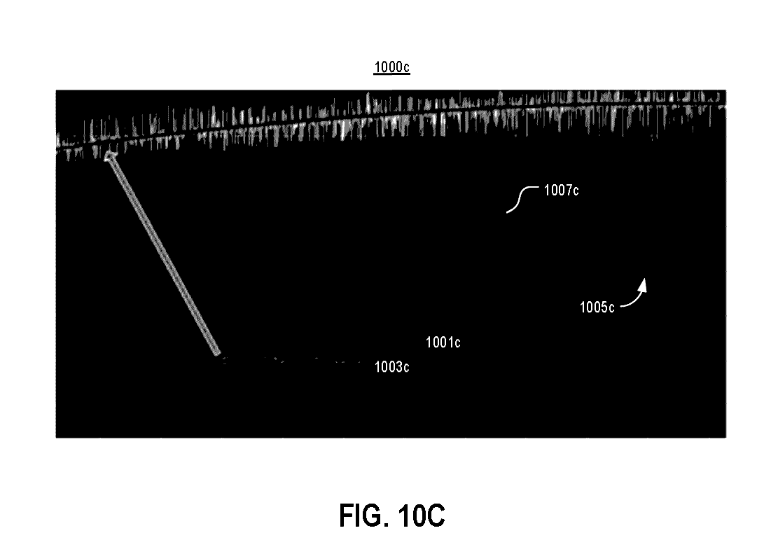

FIGS. 10A-C provide examples 1000a-c of determining duty cycles of power control signals based on a portion of a power delivery profile that corresponds to a certain position in an operation phase of an electronic device in accordance with various aspects described herein. In electric motors, magnetic fields may be formed in both a rotor and a stator. The stator may be a stationary part of the electromagnetic circuit of the electric motor, which may include windings or permanent magnets. The rotor may be used to deliver the mechanical power such as by rotating a shaft of the electric motor. The rotor may have conductors, which carry currents that interact with the magnetic field of the stator, to generate the forces that turn the shaft. However, in some embodiments, the rotor may have permanent magnets while the stator has the conductors. The product between these two electromagnetic fields formed in both the rotor and the stator may give rise to a force such as a torque on the shaft. Further, one or both of these electromagnetic fields may be made to change with the rotation of the rotor about the shaft. FIG. 10A shows a pattern of positive and negative pulses such as PWM pulses applied to stators of a permanent magnet motor. The speed of the permanent magnet motor may be controlled by varying the duty cycle of the pulses applied to the stators. FIG. 10B shows pulses used to generate an alternating current (AC) pattern. In one instance, a controller such as an advanced vector motor controller may be used to generate these pulses.

In FIG. 10C, the power delivery profile 1001c represents predetermined power (e.g., current) to be delivered to an electronic device in the operation phase of the electronic device. The power consumed 1003c (e.g., current) by the electronic device may be tracked by the controller described herein so that a duty cycle of each power control signal 1005c may be adapted based on the power consumed 1003c and the power delivery profile 1001c proximate a certain position (e.g., time) in the operation phase of the electronic device. As shown in FIG. 10C, a duty cycle of each of the power control signals, as represented by the highlighted region 1007c, may be adapted based on a change to the power consumed by the electronic device, as represented by line 1003c.

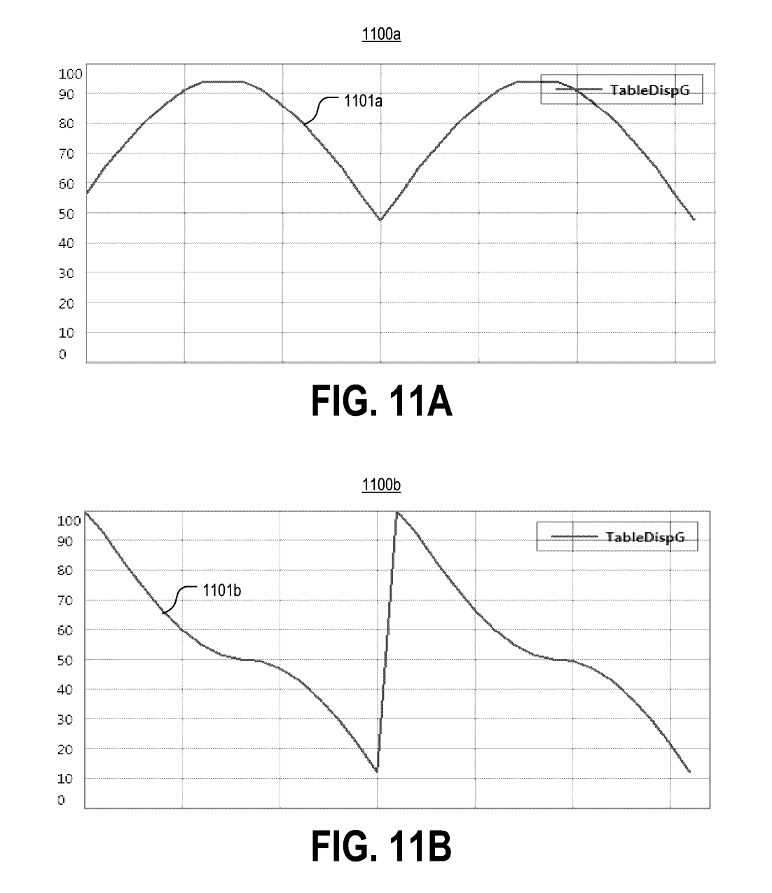

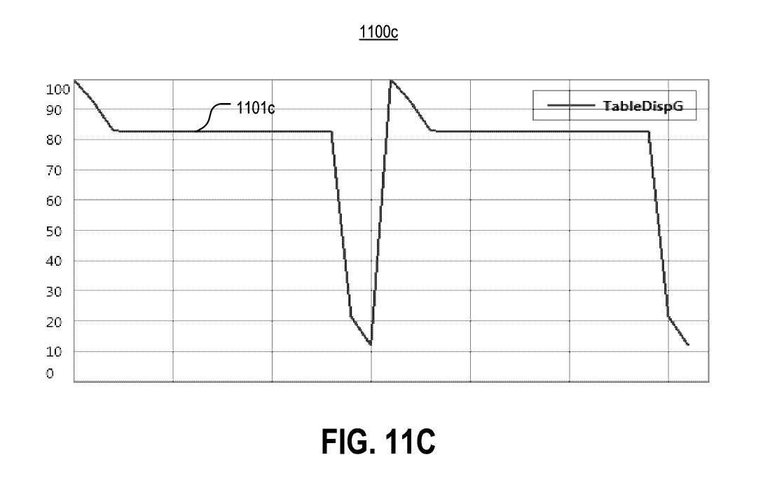

FIGS. 11A-C provide examples 1100a-c of power delivery profiles 1101a-c of electrical devices in accordance with various aspects described herein. Instead of providing power control signals having a constant duty cycle, a constant frequency, an AC pattern or the like, the use of the power delivery profiles 1101a-c allows the controller described herein to determine different duty cycles or frequencies for the power control signals to control a power supply signal so that the controlled power supply signal delivered to the electronic device results in more power efficiency or better performance by the electronic device.

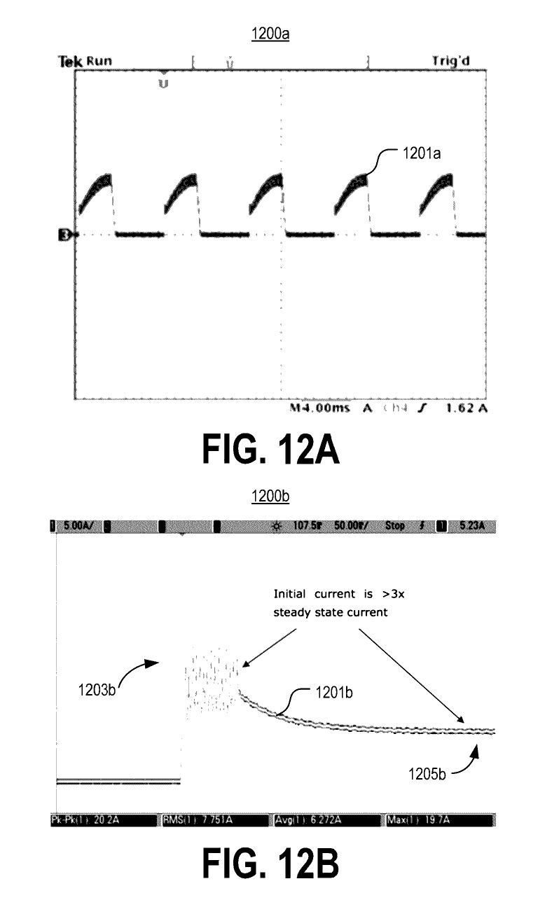

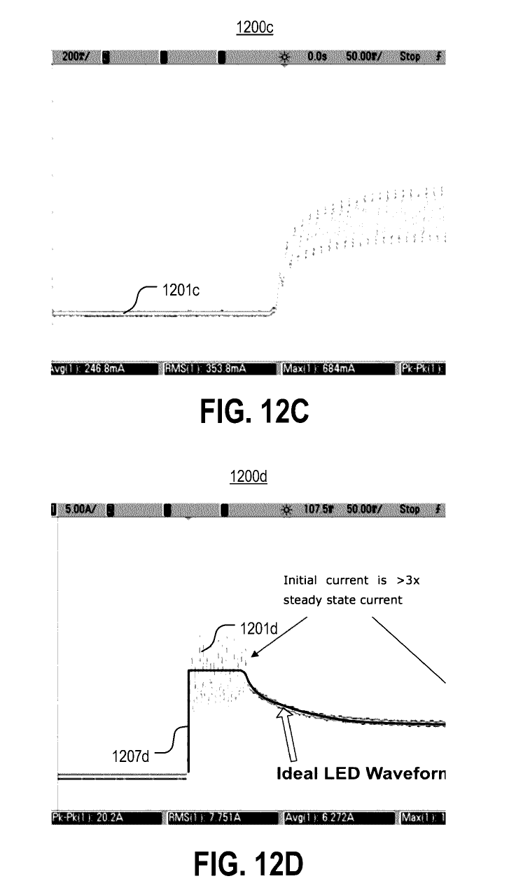

FIGS. 12A-D provide an example 1200a-d of determining a power delivery profile of the electrical device in accordance with various aspects described herein. FIG. 12A shows the consumed current 1201a by a light emitting diode (LED). The current waveform 1201a shows a soft start following by increased consumed current by the LED until turned off. As shown in FIG. 12B, an LED may initially pull a larger amount of current, as referenced by 1203b, that may be greater than three times the steady-state current, as referenced by 1205b. This initial pull may result in the LED consuming more power than required or even being damaged. To overcome this initial pull, as shown in FIG. 12C, typical LED drivers will generate a soft start, resulting in the consumed current 1201c by the LED. However, these LED drivers cause ripples, requiring analog filters to filter out the resulting noise. FIG. 12D shows a power delivery profile 1207d that includes the decreased consumed current of FIG. 12B and the soft start of FIG. 12C, resulting in reduced power consumption by the LED.

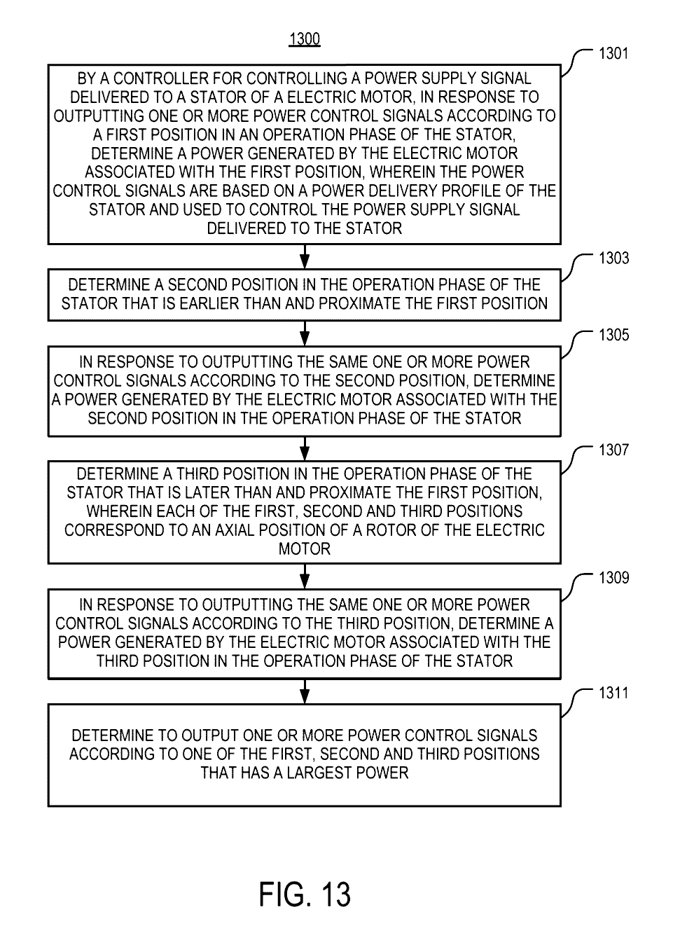

FIG. 13 illustrates one embodiment of a method 1300 of controlling a supply signal delivered to a stator of an electric motor in accordance with various aspects described herein. In FIG. 13, the method 1300 may start, for instance, at block 1301 where it may include determining a power generated by the electric motor associated with a first position in an operation phase of the stator responsive to outputting one or more power control signals according to the first position. The power control signals may be based on a power delivery profile of the stator and may be used to control the power supply signal delivered to the stator. At block 1303, the method 1300 may include determining a second position in the operation phase of the stator that is earlier than and proximate the first position. In response to outputting the same one or more power control signals according to the second position, the method 1300 may include determining a power generated by the electric motor associated with the second position, as referenced at block 1305.

In FIG. 13, at block 1307, the method 1300 may include determining a third position in the operation phase of the stator that is later than and proximate the first position. Each of the first, second and third positions may correspond to an axial position of a rotor of the electric motor. In one example, the axial position of the rotor that corresponds to the second position may be any degree (e.g., 1°, 2°, 5°, 10°, 20° or the like) or fraction of a degree (e.g., 0.1°, 0.5°, 1.5°, 2.5° or the like) earlier than the axial position of the rotor that corresponds to the first position. In another example, the axial position of the rotor that corresponds to the second position may in a range from 0° to 20° earlier than the axial position of the rotor that corresponds to the first position. In another example, the axial position of the rotor that corresponds to the third position may be any degree (e.g., 1°, 2°, 5°, 10°, 20° or the like) or fraction of a degree (e.g., 0.1°, 0.5°, 1.5°, 2.5° or the like) later than the axial position of the rotor that corresponds to the first position. In another example, the axial position of the rotor that corresponds to the third position may in a range from 0° to 20° later than the axial position of the rotor that corresponds to the first position. In response to outputting the same one or more power control signals according to the third position, the method 1300 may include determining a power generated by the electric motor associated with the third position in the operation phase of the stator, as referenced at block 1309. At block 1311, the method 1300 may include determining to output one or more power control signals according to one of the first, second and third positions that has a largest power.

In one embodiment, a method performed by a controller for controlling a power supply signal delivered to an electronic device may include obtaining one or more power control signals based on a portion of a power delivery profile of the electronic device that corresponds to a certain position in an operation phase of the electronic device. The power delivery profile may represent predetermined power to be delivered to the electronic device in the operation phase of the electronic device. Further, each power control signal may be related to the predetermined power to be delivered to the electronic device proximate a corresponding position in the operation phase of the electronic device. Also, the method may include outputting the one or more power control signals proximate the certain position to control the power supply signal delivered to the electronic device so that a power consumed by the electronic device corresponds to the predetermined power to be delivered to the electronic device proximate the certain position.

In another embodiment, the method may include determining the certain position in the operation phase of the electronic device.

In another embodiment, the method may include receiving an indication of the certain position in the operation phase of the electronic device. In response to receiving the indication of the certain position in the operation phase of the electronic device, the method may include determining the certain position in the operation phase of the stator based on the indication of the certain position.

In another embodiment, the method step of obtaining one or more power control signals may include determining a duty cycle or frequency of the one or more power control signals based on the portion of the power delivery profile that corresponds to the certain position. Further, a duty cycle or frequency of each power control signal is related to the predetermined power to be delivered to the electronic device proximate the certain position. In addition, this method step may include generating the one or more power control signals based on the determined duty cycle or frequency.

In another embodiment, the method step of determining the duty cycle or frequency of the one or more power control signals based on a portion of the power delivery profile that corresponds to the certain position may include adapting the duty cycle or frequency of the one or more power control signals based on the consumed power and the predetermined power proximate the certain position.

In another embodiment, the method step of adapting the duty cycle or frequency of the one or more power control signals may include adjusting the duty cycle or frequency of the one or more power control signals when the consumed power is different than the predetermined power proximate the certain position.

In another embodiment, the method step of adapting the duty cycle or frequency of the one or more power control signals may include adjusting the duty cycle or frequency of the one or more power control signals when the consumed power is different than the predetermined power proximate the certain position.

In another embodiment, the method step of adapting the duty cycle or frequency of the one or more power control signals may include increasing or decreasing the duty cycle or frequency of the one or more power control signals when the consumed power is respectively less than or greater than the predetermined power proximate the certain position.

In another embodiment, each power control signal may be one or more pulse signals having a certain duty cycle or frequency.

In another embodiment, each power control signal may be one or more pulse-width modulated signals.

In another embodiment, each power control signal may be a pseudo-random binary sequence having a certain duty cycle.

In another embodiment, a frequency of at least two power control signals may be different.

In one embodiment, a controller for controlling a power supply signal delivered to an electronic device may be configured to include an obtainer circuit and an output circuit. The obtainer circuit may be configured to obtain one or more power control signals based on a portion of a power delivery profile of the electronic device that corresponds to a certain position in an operation phase of the electronic device. The power delivery profile may represent predetermined power to be delivered to the electronic device in the operation phase of the electronic device. Further, each power control signal may be related to the predetermined power to be delivered to the electronic device proximate a corresponding position in the operation phase of the electronic device. The output circuit may be configured to output the one or more power control signals proximate the certain position to control the power supply signal delivered to the electronic device so that a power consumed by the electronic device corresponds to the predetermined power to be delivered to the electronic device proximate the certain position.

In another embodiment, the obtainer circuit may be further configured to determine the certain position in the operation phase of the electronic device.

In another embodiment, the controller may be further configured to include a receiver circuit. The receiver circuit may be configured to receive an indication of the certain position in the operation phase of the electronic device. Further, the obtainer circuit may be further configured to determine the certain position in the operation phase of the stator based on the indication of the certain position.

In another embodiment, the obtainer circuit may be further configured to determine a duty cycle or frequency of the one or more power control signals based on the portion of the power delivery profile that corresponds to the certain position. Further, the duty cycle or frequency of each power control signal may be related to the predetermined power to be delivered to the electronic device proximate the certain position. In addition, the obtainer circuit may be further configured to generate the one or more power control signals based on the determined duty cycle or frequency.

In another embodiment, the obtainer circuit may be further configured to adapt the duty cycle or frequency of the one or more power control signals based on the consumed power and the predetermined power proximate the certain position.

In another embodiment, the obtainer circuit may be further configured to adjust the duty cycle or frequency of the one or more power control signals when the consumed power is different than the predetermined power proximate the certain position.

In another embodiment, the obtainer circuit may be further configured to increase or decrease the duty cycle or frequency of the one or more power control signals when the consumed power is respectively less than or greater than the predetermined power proximate the certain position.

In one embodiment, a system for controlling a power supply signal delivered to an electronic device may include a power supply, a switch device and a controller. The power supply may provide a power supply signal. The switch device may be operationally coupled between the electrical device and the power supply. The controller may be operationally coupled to the switch device. Further, the controller may be configured to obtain one or more power control signals based on a portion of a power delivery profile of the electronic device that corresponds to a certain position in an operation phase of the electronic device. The power delivery profile may represent predetermined power to be delivered to the electronic device in the operation phase of the electronic device. Further, each of the one or more power control signals being related to the predetermined power to be delivered to the electronic device proximate a certain position in the operation phase of the electronic device. In addition, the controller may output, to the switch device, the one or more power control signals proximate the certain position to control the power supply signal delivered to the electronic device so that a power consumed by the electronic device corresponds to the predetermined power delivered to the electronic device proximate the certain position.

In one embodiment, a method performed by a controller for controlling a power supply signal delivered to a stator of an electric motor may include obtaining one or more power control signals based on a portion of a power delivery profile of the stator that corresponds to a certain position in an operation phase of the stator. The power delivery profile may represent predetermined power to be delivered to the stator in the operation phase of the electronic device. Further, each power control signal may be related to the predetermined power to be delivered to the stator proximate a corresponding position in the operation phase of the stator. Also, the certain position may be determined based on an axial position of a rotor of the electric motor. In addition, the method may include outputting the one or more power control signals proximate the certain position to control the power supply signal delivered to the stator so that a power consumed by the stator corresponds to the predetermined power to be delivered to the stator proximate the certain position.

In another embodiment, the method may include determining the certain position in the operation phase of the stator.

In another embodiment, the method may include receiving an indication of the certain position of the rotor. In response to receiving the indication of the position of the rotor, the method may include determining the certain position in the operation phase of the stator based on the indication of the position of the rotor.

In another embodiment, the method step of obtaining the one of the plurality of power control signals may include determining a duty cycle or frequency of the one or more power control signals based on the portion of the power delivery profile that corresponds to the certain position. Further, the duty cycle or frequency of each power control signal may be related to the predetermined power to be delivered to the stator proximate the certain position of the rotor. In addition, the method step of obtaining the one of the plurality of power control signals may include generating the one or more power control signals based on the determined duty cycle or frequency.

In another embodiment, the method step of determining the duty cycle or frequency of each power control signal may include adapting the duty cycle or frequency of the one or more power control signals based on the consumed power by the stator and the predetermined power of the stator proximate the certain position.

In another embodiment, the method step of adapting the duty cycle or frequency of the one or more power control signals may include adjusting the duty cycle or frequency of the one or more power control signals when the consumed power is different than the predetermined power proximate the certain position.

In another embodiment, the method step of adapting the duty cycle or frequency of the one or more power control signals may include increasing or decreasing the duty cycle or frequency of the one or more power control signals when the consumed power is respectively less than or greater than the predetermined power proximate the certain position.

In one embodiment, a controller for controlling a power supply signal delivered to a stator of an electric motor may be configured to include an obtainer circuit and an output circuit. The obtainer circuit may be configured to obtain one or more power control signals based on a portion of a power delivery profile of the stator that corresponds to a certain position in the operation phase of the stator. The power delivery profile may represent predetermined power to be delivered to the stator in the operation phase of the electronic device. Further, each power control signal may be related to the predetermined power to be delivered to the stator proximate a corresponding position in the operation phase of the stator. Also, the certain position may be determined based on an axial position of a rotor of the electric motor. The output circuit may be configured to output the one or more power control signals proximate the certain position to control the power supply signal delivered to the stator so that a power consumed by the stator corresponds to the predetermined power to be delivered to the stator proximate the certain position.

In another embodiment, the controller may be further configured to determine the certain position in the operation phase of the stator.

In another embodiment, the controller may be configured to further include a receiver circuit. The receiver circuit may be configured to receive an indication of the certain position of the rotor. In response to receiving the indication of the position of the rotor, the controller may be further configured to determine the certain position based on the indication of the certain position.

In another embodiment, the obtainer circuit may be further configured to determine a duty cycle or frequency of the one or more power control signals based on the portion of the power delivery profile that corresponds to the certain position of the rotor. Further, the duty cycle or frequency of each power control signal may be related to the predetermined power to be delivered to the stator proximate the certain position. In addition, the obtainer circuit may be further configured to generate the one or more power control signals based on the determined duty cycle or frequency.

In another embodiment, the obtainer circuit may be configured to adapt the duty cycle or frequency of the one or more power control signals based on the consumed power by the stator and the predetermined power to be delivered to the stator proximate the certain position.

In another embodiment, the obtainer circuit may be configured to adjust the duty cycle or frequency of the one or more power control signals when the consumed power is different than the predetermined power proximate the certain position.

In another embodiment, the obtainer circuit may be further configured to increase or decrease the duty cycle or frequency of the one or more power control signals when the consumed power is respectively less than or greater than the predetermined power proximate the certain position.

In one embodiment, a system for controlling a power supply signal delivered to a stator of an electric motor may include a power supply, a switch device and a controller. The power supply may provide a power supply signal. The switch device may be operationally coupled between the stator of the electric motor and the power supply. The controller may be operationally coupled to the switch device and may be configured to obtain one or more power control signals based on a portion of a power delivery profile of the stator that corresponds to a certain position in an operation phase of the stator. The power delivery profile may represent predetermined power to be delivered to the stator in the operation phase of the electronic device. Further, each power control signal may be related to the predetermined power to be delivered to the stator proximate a corresponding position in the operation phase of the stator. Also, the certain position may be determined based on an axial position of a rotor of the electric motor. The controller may be further configured to output, to the switch device, the one or more power control signals proximate the certain position to control the power supply signal delivered to the stator so that a power consumed by the stator corresponds to the predetermined power to be delivered to the stator proximate the certain position.

In one embodiment, a method performed by a controller for controlling a power supply signal delivered to a light source device may include obtaining one or more power control signals based on a portion of a power delivery profile of the light source device that corresponds to a certain position in an operation phase of the light source device. The power delivery profile may represent predetermined power to be delivered to the light source device in the operation phase of the light source device. Also, each power control signal may be related to the predetermined power to be delivered to the light source device proximate a corresponding position in the operation phase of the light source device and the certain position may be determined based on a certain time in the operation phase of the light source device. Further, the method may include outputting the one or more power control signals proximate the certain position to control the power supply signal delivered to the light source device so that a power consumed by the light source device corresponds to the predetermined power to be delivered to the light source device proximate the certain position.

In another embodiment, the method may include determining the certain position in the operation phase of the light source device.

In another embodiment, the method may include receiving an indication of the time in the operation phase of the light source device. In response to receiving the indication of the time in the operation phase of the light source device, the method may include determining the certain position in the operation phase of the light source device based on the indication of the time.

In another embodiment, the method step of obtaining may include determining a duty cycle or frequency of the one or more power control signals based on the portion of the power delivery profile that corresponds to the certain position. The duty cycle or frequency of each power control signal may be related to the predetermined power to be delivered to the light source device proximate the certain position. Further, the method step of obtaining may include generating the one or more power control signals based on the determined duty cycle or frequency.

In another embodiment, the method step of determining the duty cycle or frequency of the one or more power control signals may include adapting the duty cycle or frequency of the one or more power control signals based on the consumed power and the predetermined power proximate the certain position.

In another embodiment, the method step of adapting the duty cycle or frequency of the one or more power control signals may include adjusting the duty cycle or frequency of the one or more power control signals when the consumed power is different than the predetermined power proximate the certain position.

In another embodiment, the method step of adapting the duty cycle or frequency of the one or more power control signals may include increasing or decreasing the duty cycle or frequency of the one or more power control signals when the consumed power is respectively less than or greater than the predetermined power proximate the certain position.

In one embodiment, a controller for controlling a power supply signal delivered to light source device may include an obtainer circuit and an output circuit. The obtainer circuit may be configured to obtain one or more power control signals based on a portion of a power delivery profile of the light source device that corresponds to a certain position in an operation phase of the light source device. The power delivery profile may represent predetermined power to be delivered to the light source device in the operation phase of the light source device. Also, each power control signal may be related to the predetermined power to be delivered to the light source device proximate a corresponding position in the operation phase of the light source device and the certain position may be determined based on a certain time in the operation phase of the light source device. Further, the output circuit may be configured to output the one or more power control signals proximate the certain position to control the power supply signal delivered to the light source device so that a power consumed by the light source device corresponds to the predetermined power to be delivered to the light source device proximate the certain position.

In another embodiment, the obtainer circuit may be further configured to determine the certain position in the operation phase of the light source device.

In another embodiment, the controller may include a receiver circuit. The receiver circuit may be configured to receive an indication of the time in the operation phase of the light source device. In response to receiving the indication of the time in the operation phase of the light source device, the obtainer circuit may be configured to determine the certain position in the operation phase of the light source device based on the indication of the time.

In another embodiment, the obtainer circuit may be further configured to determine a duty cycle or frequency of the one or more power control signals based on the portion of the power delivery profile that corresponds to the certain position. The duty cycle or frequency of each power control signal is related to the predetermined power to be delivered to the light source device proximate the certain position. In addition, the obtainer circuit may be further configured to generate the one or more power control signals based on the determined duty cycle or frequency.

In another embodiment, the obtainer circuit may be further configured to adapt the duty cycle or frequency of the one or more power control signals based on the consumed power and the predetermined power proximate the certain position.

In another embodiment, the obtainer circuit may be further configured to adjust the duty cycle or frequency of the one or more power control signals when the consumed power is different than the predetermined power proximate the certain position.

In another embodiment, the obtainer circuit may be further configured to increase or decrease the duty cycle or frequency of the one or more power control signals when the consumed power is respectively less than or greater than the predetermined power proximate the certain position.

In one embodiment, a system for controlling a power supply signal delivered to light source device may be configured to include a power supply, a switch device and a controller. The power supply may provide a power supply signal. The switch device may be operationally coupled between the light source device and the power supply. The controller may be operationally coupled to the switch device and may be configured to obtain one or more power control signals based on a portion of a power delivery profile of the light source device that corresponds to a certain position in an operation phase of the light source device. The power delivery profile may represent predetermined power to be delivered to the light source device in the operation phase of the light source device. Also, each power control signal may be related to the predetermined power to be delivered to the light source device proximate a corresponding position in the operation phase of the light source device and the certain position may be determined based on a certain time in the operation phase of the light source device. Further, the controller may be configured to output the one or more power control signals proximate the certain position to control the power supply signal delivered to the light source device so that a power consumed by the light source device corresponds to the predetermined power to be delivered to the light source device proximate the certain position.

In one embodiment, a non-transitory computer-readable medium may be encoded with a computer program. Further, the computer program may comprise computer-executable instructions that when executed by a processor causes the processor to perform operations. The operations may be configured to obtain one or more power control signals based on a portion of a power delivery profile of the electronic device that corresponds to a certain position in an operation phase of the electronic device. The power delivery profile may represent predetermined power to be delivered to the electronic device in the operation phase of the electronic device. Further, each power control signal may be related to the predetermined power to be delivered to the electronic device proximate a corresponding position in the operation phase of the electronic device. In addition, the operation may be configured to output the one or more power control signals proximate the certain position to control the power supply signal delivered to the electronic device so that a power consumed by the electronic device corresponds to the predetermined power to be delivered to the electronic device proximate the certain position.

In another embodiment, the operations may be further configured to determine the certain position in the operation phase of the electronic device.

In another embodiment, the operations may be further configured to determine a duty cycle or frequency of the one or more power control signals based on the portion of the power delivery profile that corresponds to the certain position. Further, the duty cycle or frequency of each power control signal may be related to the predetermined power to be delivered to the electronic device proximate the certain position. Also, the operations may be further configured to generate the one or more power control signals based on the determined duty cycle or frequency.

In another embodiment, the operations may be further configured to adapt the duty cycle or frequency of the one or more power control signals based on the consumed power and the predetermined power proximate the certain position.

In another embodiment, the operations may be further configured to adjust the duty cycle or frequency of the one or more power control signals when the consumed power is different than the predetermined power proximate the certain position.

In another embodiment, the operations may be further configured to increase or decrease the duty cycle or frequency of the one or more power control signals when the consumed power is respectively less than or greater than the predetermined power proximate the certain position.

In one embodiment, a controller for controlling a power supply signal delivered to an electronic device may comprise an obtaining module and an outputting module. The obtaining module may be configured for obtaining one or more power control signals based on a portion of a power delivery profile of the electronic device that corresponds to a certain position in an operation phase of the electronic device. The power delivery profile may represent predetermined power to be delivered to the electronic device in the operation phase of the electronic device. Further, each power control signal may be related to the predetermined power to be delivered to the electronic device proximate a corresponding position in the operation phase of the electronic device. The outputting module may be configured for outputting the one or more power control signals proximate the certain position to control the power supply signal delivered to the electronic device so that a power consumed by the electronic device corresponds to the predetermined power to be delivered to the electronic device proximate the certain position.

In another embodiment, the obtaining module may be further configured to determine the certain position in the operation phase of the electronic device.

In another embodiment, the obtaining module may be further configured to determine a duty cycle or frequency of the one or more power control signals based on the portion of the power delivery profile that corresponds to the certain position. The duty cycle or frequency of each power control signal may be related to the predetermined power to be delivered to the electronic device proximate the certain position. Also, the obtaining module may be further configured to generate the one or more power control signals based on the determined duty cycle or frequency.

In another embodiment, the obtaining module may be further configured to adapt the duty cycle or frequency of the one or more power control signals based on the consumed power and the predetermined power proximate the certain position.

In another embodiment, the obtaining module may be further configured to adjust the duty cycle or frequency of the one or more power control signals when the consumed power is different than the predetermined power proximate the certain position.

In another embodiment, the obtaining module being further configured to increase or decrease the duty cycle or frequency of the one or more power control signals when the consumed power is respectively less than or greater than the predetermined power proximate the certain position.

The previous detailed description is merely illustrative in nature and is not intended to limit the present disclosure, or the application and uses of the present disclosure. Furthermore, there is no intention to be bound by any expressed or implied theory presented in the preceding field of use, background, summary, or detailed description. The present disclosure provides various examples, embodiments and the like, which may be described herein in terms of functional or logical block elements. The various aspects described herein are presented as methods, devices (or apparatus), systems, or articles of manufacture that may include a number of components, elements, members, modules, nodes, peripherals, or the like. Further, these methods, devices, systems, or articles of manufacture may include or not include additional components, elements, members, modules, nodes, peripherals, or the like.

Furthermore, the various aspects described herein may be implemented using standard programming or engineering techniques to produce software, firmware, hardware (e.g., circuits), or any combination thereof to control a computing device to implement the disclosed subject matter. It will be appreciated that some embodiments may be comprised of one or more generic or specialized processors such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods, devices and systems described herein. Alternatively, some or all functions could be implemented by a state machine that has no stored program instructions, or in one or more application specific integrated circuits (ASICs), in which each function or some combinations of certain of the functions are implemented as custom logic circuits. Of course, a combination of the two approaches may be used. Further, it is expected that one of ordinary skill, notwithstanding possibly significant effort and many design choices motivated by, for example, available time, certain technology, and economic considerations, when guided by the concepts and principles disclosed herein will be readily capable of generating such software instructions and programs and ICs with minimal experimentation.

The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the subject matter of this disclosure.

Throughout the specification and the embodiments, the following terms take at least the meanings explicitly associated herein, unless the context clearly dictates otherwise. Relational terms such as “first” and “second,” and the like may be used solely to distinguish one entity or action from another entity or action without necessarily requiring or implying any actual such relationship or order between such entities or actions. The term “or” is intended to mean an inclusive “or” unless specified otherwise or clear from the context to be directed to an exclusive form. Further, the terms “a,” “an,” and “the” are intended to mean one or more unless specified otherwise or clear from the context to be directed to a singular form. The term “include” and its various forms are intended to mean including but not limited to. References to “one embodiment,” “an embodiment,” “example embodiment,” “various embodiments,” and other like terms indicate that the embodiments of the disclosed technology so described may include a particular function, feature, structure, or characteristic, but not every embodiment necessarily includes the particular function, feature, structure, or characteristic. Further, repeated use of the phrase “in one embodiment” does not necessarily refer to the same embodiment, although it may. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

What is claimed is:

1. A method performed by a controller for controlling a power supply signal delivered to an electronic device, comprising:
obtaining one or more power control signals based on a portion of a power delivery profile of the electronic device that corresponds to a certain position in an operation phase of the electronic device, wherein the power delivery profile represents predetermined power to be delivered to the electronic device in the operation phase of the electronic device, with each power control signal being related to the predetermined power to be delivered to the electronic device proximate a corresponding position in the operation phase of the electronic device; and
outputting the one or more power control signals proximate the certain position to control the power supply signal delivered to the electronic device so that a power consumed by the electronic device corresponds to the predetermined power to be delivered to the electronic device proximate the certain position.

2. The method of claim 1, wherein said obtaining includes:
determining the certain position in the operation phase of the electronic device.

3. The method of claim 1, wherein said obtaining includes:
determining a duty cycle or frequency of the one or more power control signals based on the portion of the power delivery profile that corresponds to the certain position, wherein the duty cycle or frequency of each power control signal is related to the predetermined power to be delivered to the electronic device proximate the certain position; and
generating the one or more power control signals based on the determined duty cycle or frequency.

4. The method of claim 3, wherein said determining the duty cycle or frequency includes:
adapting the duty cycle or frequency of the one or more power control signals based on the consumed power and the predetermined power proximate the certain position.

5. The method of claim 4, wherein said adapting includes:
adjusting the duty cycle or frequency of the one or more power control signals when the consumed power is different than the predetermined power proximate the certain position.

6. The method of claim 5, wherein said adapting includes:
increasing or decreasing the duty cycle or frequency of the one or more power control signals when the consumed power is respectively less than or greater than the predetermined power proximate the certain position.

7. The method of claim 1, wherein each power control signal is one or more pulse signals having a certain duty cycle or frequency.

8. The method of claim 1, wherein each power control signal is one or more pulse-width modulated signals.

9. The method of claim 1, wherein each power control signal is a pseudo-random binary sequence having a certain duty cycle.

10. The method of claim 1, wherein a frequency of at least two power control signals is different.

11. A controller for controlling a power supply signal delivered to an electronic device, comprising:
an obtainer circuit configured to obtain one or more power control signals based on a portion of a power delivery profile of the electronic device that corresponds to a certain position in an operation phase of the electronic device, wherein the power delivery profile represents predetermined power to be delivered to the electronic device in the operation phase of the electronic device, with each of the one or more power control signals being related to the predetermined power to be delivered to the electronic device proximate a certain position in the operation phase of the electronic device; and
an output circuit configured to output the one or more power control signals proximate the certain position to control the power supply signal delivered to the electronic device so that a power consumed by the electronic device corresponds to the predetermined power to be delivered to the electronic device proximate the certain position.

12. The controller of claim 11, wherein said obtaining includes the obtainer circuit being further configured to:
determine the certain position in the operation phase of the electronic device.

13. The controller of claim 11, wherein said obtaining includes the obtainer circuit being further configured to:
determine a duty cycle or frequency of the one or more power control signals based on the portion of the power delivery profile that corresponds to the certain position, wherein the duty cycle or frequency of each power control signal is related to the predetermined power to be delivered to the electronic device proximate the certain position; and
generate the one or more power control signals based on the determined duty cycle or frequency.

14. The controller of claim 13, wherein said determining the duty cycle or frequency includes the obtainer circuit being further configured to:
adapt the duty cycle or frequency of the one or more power control signals based on the consumed power and the predetermined power proximate the certain position.

15. The controller of claim 14, wherein said adapting includes the obtainer circuit being further configured to:
adjust the duty cycle or frequency of the one or more power control signals when the consumed power is different than the predetermined power proximate the certain position.

16. The controller of claim 15, wherein said adapting includes the obtainer circuit being further configured to:
increase or decrease the duty cycle or frequency of the one or more power control signals when the consumed power is respectively less than or greater than the predetermined power proximate the certain position.

17. The controller of claim 11, wherein each power control signal is one or more pulse signals having a certain duty cycle or frequency.

18. The controller of claim 11, wherein each power control signal is one or more pulse-width modulated signals.

19. The controller of claim 11, wherein each power control signal is a pseudo-random binary sequence having a certain duty cycle.

20. A system for controlling a power supply signal delivered to an electronic device, comprising:
a power supply providing a power supply signal;
a switch device operationally coupled between the electrical device and the power supply; and
a controller operationally coupled to the switch device and configured to:
obtain one or more power control signals based on a portion of a power delivery profile of the electronic device that corresponds to a certain position in an operation phase of the electronic device, wherein the power delivery profile represents predetermined power to be delivered to the electronic device in the operation phase of the electronic device, with each of the one or more power control signals being related to the predetermined power to be delivered to the electronic device proximate a certain position in the operation phase of the electronic device; and
output, to the switch device, the one or more power control signals proximate the certain position to control the power supply signal delivered to the electronic device so that a power consumed by the electronic device corresponds to the predetermined power delivered to the electronic device proximate the certain position.
